(19) United States
(12) Patent Application Publication
(10) Pub. No.: US 2025/0023084 A1
(43) Pub. Date: Jan. 16, 2025

(54) VENTILATION APPARATUS FOR FUEL CELL AND MANUFACTURING METHOD FOR FUEL CELL

(71) Applicant: Honda Motor Co., Ltd., Tokyo (JP)

(72) Inventor: Takuma Nozaki, Saitama (JP)

(21) Appl. No.: 18/764,545

(22) Filed: Jul. 5, 2024

(30) Foreign Application Priority Data
Jul. 13, 2023 (JP) 2023-114858

(51) Int. Cl. H01M 8/2484; H01M 8/2404; H01M 8/2475

(52) U.S. Cl. CPC H01M 8/2484; H01M 8/2404; H01M 8/2475; H01M 2250/20

(57) ABSTRACT

A ventilation apparatus for a fuel cell including a fuel cell case accommodating a stacked body formed by stacking power generation cells and a ventilation unit attached to the fuel cell case so as to cover an opening provided at the fuel cell case, an internal space and an external space of the fuel cell case communicating through the opening. The ventilation unit includes a filter disposed facing the opening, a holding member formed in a frame shape and attached to the fuel cell case to hold a peripheral portion of the filter, and a cover attached to the holding member so as to cover an inside of the peripheral portion of the filter. The cover is attached to the holding member with a gap over an entire circumference of the cover between a peripheral portion of the cover and the holding member.

### CROSS-REFERENCE TO RELATED APPLICATION

This application is based upon and claims the benefit of priority from Japanese Patent Application No. 2023-114858 filed on Jul. 13, 2023, the content of which is incorporated herein by reference.

### BACKGROUND OF THE INVENTION

### Field of the Invention

This invention relates to a ventilation apparatus for a fuel cell ventilating an inner space of a fuel cell case and a manufacturing method for a fuel cell.

### Description of the Related Art

As an apparatus of this type, conventionally, there has been known an apparatus in which a filter is disposed to cover a front face of a fuel cell case and a cover member is attached to the front face of the fuel cell case through a pressing member. Such an apparatus is disclosed in, for example, Japanese Unexamined Patent Publication No. 2022-126924 (JP 2022-126924 A). In the apparatus described in JP2022-126924A, slit-shaped communication holes are provided at the cover member, and outside air is taken into the fuel cell case through the communication holes and a filter. Furthermore, the front of the filter is covered with the cover member to protect the filter, and the communication holes of the cover member are formed facing the pressing member.

However, with a configuration like the apparatus described in JP2022-126924A, where the slit-shaped communication holes are formed at the position not facing the filter of the cover member as an inlet port of outside air, it is difficult to increase the opening area of the communication holes and to sufficiently take in outside air into the fuel cell case.

### SUMMARY OF THE INVENTION

An aspect of the present invention is a ventilation apparatus for a fuel cell including: a fuel cell case accommodating a stacked body formed by stacking a plurality of power generation cells; and a ventilation unit attached to the fuel cell case so as to cover an opening provided at the fuel cell case, an internal space and an external space of the fuel cell case communicating through the opening. The ventilation unit includes: a filter disposed facing the opening; a holding member formed in a frame shape and attached to the fuel cell case to hold a peripheral portion of the filter; and a cover attached to the holding member so as to cover an inside of the peripheral portion of the filter. The cover is attached to the holding member with a gap over an entire circumference of a peripheral portion of the cover between the peripheral portion of the cover and the holding member.

Another aspect of the present invention is a manufacturing method for a fuel cell, the fuel cell including a fuel cell case accommodating a stacked body formed by stacking a plurality of power generation cells and a ventilation unit attached to the fuel cell case so as to cover an opening provided at the fuel cell case, an internal space and an external space of the fuel cell case communicating through the opening, the manufacturing method including: attaching a peripheral portion of a filter arranged to face the opening to a holding member with a frame shape; attaching the holding member to the fuel cell case;

and attaching a cover to the holding member so as to cove an inside of the peripheral portion of the filter. The attaching the cover includes attaching the cover to the holding member with a gap over an entire circumference of a peripheral portion of the cover between the peripheral portion of the cover and the holding member.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack with a ventilation apparatus for a fuel cell according to an embodiment of the present invention;

FIG. 2 is a cross-sectional view along line II-II of FIG. 1;

FIG. 3 is a front view of the fuel cell stack in a state that a ventilation unit is removed from FIG. 1;

FIG. 4 is a front view of the ventilation unit of an upper ventilation apparatus attached to the fuel cell stack of FIG. 1;

FIG. 5 is an exploded perspective view of the ventilation unit of the upper ventilation apparatus attached to the fuel cell stack of FIG. 1;

FIG. 6A is a cross-sectional view along line A-A of FIG. 4;

FIG. 6B is a cross-sectional view along line B-B of FIG. 4;

FIG. 7 is an enlarged view of part VII of FIG. 5; and

FIG. 8 is a diagram showing an example of a flow of air and fuel gas in the ventilation apparatus according to the embodiment of the present invention.

### DETAILED DESCRIPTION OF THE INVENTION

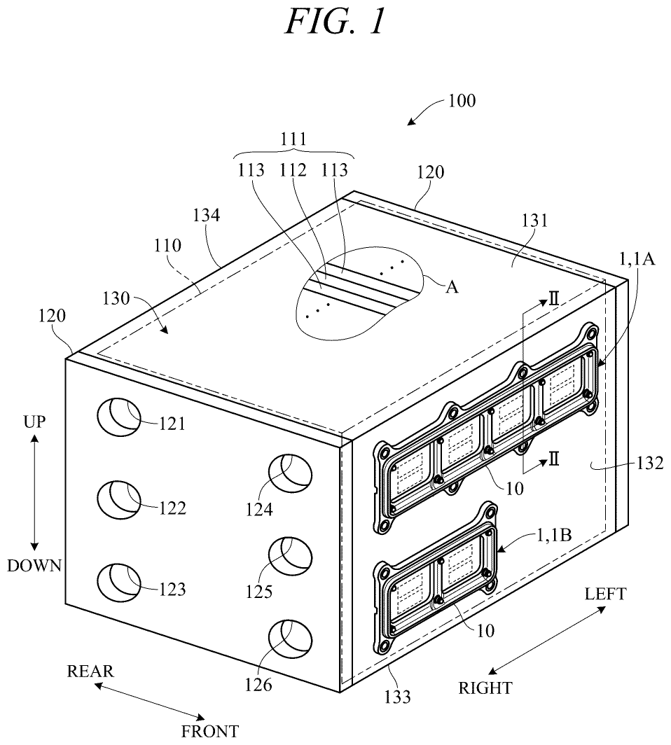

Hereinafter, embodiments of the present invention will be described with reference to FIGS. 1 to 8. A ventilation apparatus for a fuel cell according to an embodiment of the present invention can be applied to various moving bodies equipped with a fuel cell, for example. Below, an example of applying a ventilation apparatus for a fuel cell to a fuel cell vehicle that runs using electricity generated by the fuel cell will be explained. A fuel cell vehicle includes, as a main component of the fuel cell, a fuel cell stack configured by a plurality of power generation cells stacked together. The ventilation apparatus for the fuel cell according to the embodiment is provided on the fuel cell stack.

FIG. 1 is a perspective view schematically showing the overall configuration of the fuel cell stack 100 with the ventilation apparatus for the fuel cell according to the embodiment. For convenience, the three axes orthogonal to each other as shown in FIG. 1 will be defined as a front-rear direction, a left-right direction, and an up-down direction, and the configuration of each part will be explained according to this definition. The downward direction in the up-down direction corresponds to the direction of gravity. The front-rear direction and the left-right direction, for example, correspond to the front-rear direction and the left-right direction of a vehicle. The fuel cell stack 100 is provided at the front part of a vehicle, for example, so that the running wind hits its front surface.

As shown in FIG. 1, the fuel cell stack 100 has a cell stacked body (sometimes simply referred to as stacked body) 110, substantially rectangular end plates 120 arranged at both left and right ends of the cell stacked body 110, and a case (i.e., a fuel cell case) 130 that surrounds the cell stacked body 110. The case 130 has four substantially rectangular side walls, that is, a top wall 131 arranged at the top, a front wall 132 arranged at the front, a bottom wall 133 arranged at the bottom, and a rear wall 134 arranged at the rear, and the fuel cell stack 100 as a whole has a substantially rectangular parallelepiped shape. A part of the top wall 131 of the case 130 is shown by being broken away in part “A” of FIG. 1. As shown in part “A” of FIG. 1, the cell stacked body 110 is configured by a plurality of power generation cells 111 (for convenience, only a single power generation cell 111 is shown) stacked in the front-rear direction, and has a substantially rectangular parallelepiped shape as a whole.

The power generation cell 111 includes a unitized electrode assembly (UEA) 112 having a membrane electrode assembly including an electrolyte membrane and an electrode, and separators 113 and 113 that are disposed on both left and right sides of the unitized electrode assembly 112 and sandwich the unitized electrode assembly 112. The unitized electrode assembly 112 and the separators 113 are alternately disposed in the left-right direction. The left separator 113 also functions as the separator 113 for the power generation cell 111 adjacent to the left, and the right separator also functions as the separator 113 for the power generation cell 111 adjacent to the right. The separator 113 includes a pair of front and rear metal thin plates having a corrugated cross section, and is integrally formed by joining outer peripheral edges of the thin plates. A cooling flow path through which a cooling medium (for example, water) flows is formed between the pair of thin plates, and a power generation surface of the power generation cell 111 is cooled by the flow of the cooling medium.

The left separator 113 of the unitized electrode assembly 112 is, for example, a separator on an anode side (anode separator), and an anode flow path through which a fuel gas including hydrogen flows is formed between the anode separator 113 and the membrane electrode assembly of the unitized electrode assembly 112. The right separator 113 of the unitized electrode assembly 112 is, for example, a separator on a cathode side (cathode separator), and a cathode flow path through which an oxidant gas including oxygen flows is formed between the cathode separator 113 and the membrane electrode assembly of the unitized electrode assembly 112.

The unitized electrode assembly 112 includes a membrane electrode assembly and a resin frame that supports a peripheral portion of the membrane electrode assembly. The membrane electrode assembly has an electrolyte membrane, an anode electrode provided on a left surface of the electrolyte membrane, and a cathode electrode provided on a right surface of the electrolyte membrane. The electrolyte membrane is, for example, a solid polymer electrolyte membrane. The anode electrode has an electrode catalyst layer formed on a left surface of the electrolyte membrane and served as a reaction field of electrode reaction, and a gas diffusion layer formed on a left surface of the electrode catalyst layer to spread and supply the fuel gas. The cathode electrode has an electrode catalyst layer formed on a right surface of the electrolyte membrane and served as a reaction field of electrode reaction, and a gas diffusion layer formed on a right surface of the electrode catalyst layer to spread and supply the oxidant gas.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the unitized electrode assembly 112.

In the right end plate 120, through-holes 121 to 126, which penetrate the end plate 120 in the left-right direction, are opened. The through-holes 121 to 123 are offset from each other in the up-down direction near the rear end of the end plate 120, and the through-holes 124 to 126 are offset from each other in the up-down direction near the front end of the end plate 120. The left end plate 120 does not have through-holes 121 to 126 opened, and the left side of the fuel cell stack 100 is closed. Inside the cell stacked body 110, fuel gas is supplied through the through-hole 121, oxidant gas is supplied through the through-hole 124, and cooling medium is supplied through the through-hole 125. From the cell stacked body 110, the cooling medium is discharged outside the fuel cell stack 100 through the through-hole 122, the oxidant exhaust gas through the through-hole 123, and the fuel exhaust gas through the through-hole 126, respectively.

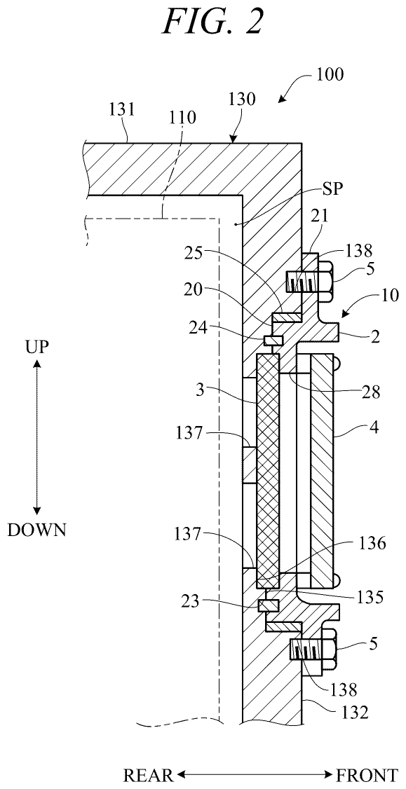

Although not shown, the cell stacked body 110 is supported from the inner wall of the case 130 through multiple support members made of, for example, resin material. The support members are provided, for example, at the central parts in the front-rear direction of the top wall 131 and the bottom wall 133, and at the central parts in the vertical direction of the front wall 132 and the rear wall 134, and are extended in the left-right direction. Therefore, except for the locations where the support members are installed, a gap (internal space) SP is provided between the cell stacked body 110 and the inner wall of the case 130, as shown in FIG. 2. The support members can also be provided at the intersections between the side walls of the case 130, such as the intersection between the top wall 131 and the front wall 132, and the intersection between the front wall 132 and the bottom wall 133.

Incidentally, a small amount of fuel gas may leak from the cell stacked body 110 of the fuel cell stack 100, for example, from the stacking surface of the power generation cells. The leaked fuel gas accumulates in the internal space SP of the case 130, so it is necessary to discharge the fuel gas accumulated in the internal space SP to the outside. In the embodiment, the fuel gas in the internal space SP is discharged to the outside of the case 130 by ventilating the internal space SP through a ventilation apparatus. Below, the configuration of the ventilation apparatus will be described.

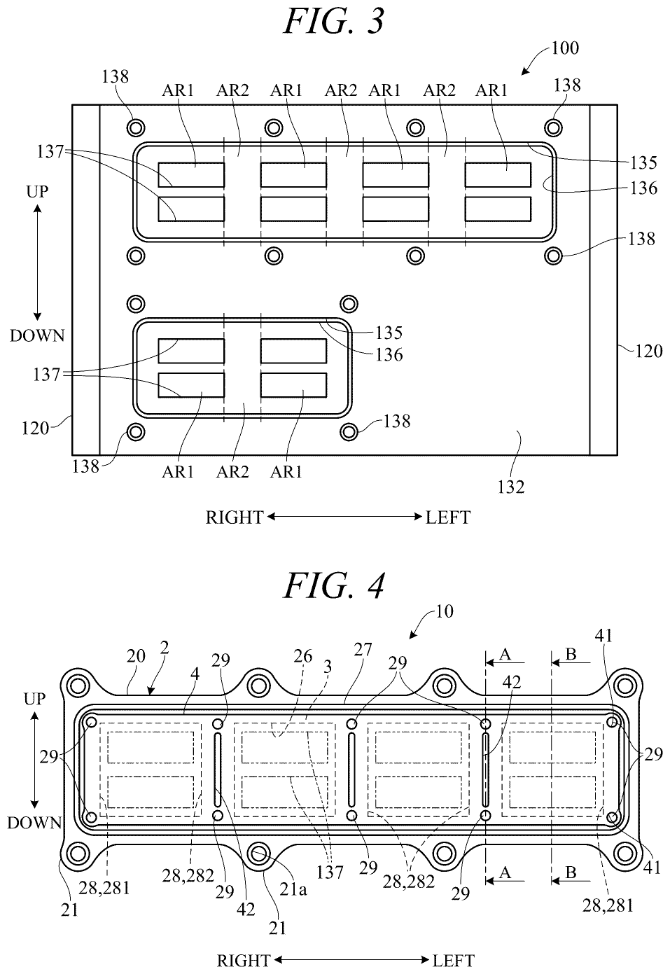

As shown in FIG. 1, the ventilation apparatus 1 of the embodiment is provided at the upper and lower portions of the front wall 132 among the multiple side walls of the case 130, which extends in the stacking direction (left-right direction) of the multiple power generation cells 111. The ventilation apparatus 1 on the upper side may be called a upper ventilation apparatus 1A, and the ventilation apparatus 1 on the lower side may be called a lower ventilation apparatus 1B. The ventilation apparatus 1 includes a ventilation unit 10 that is detachably attached to the front surface of the front wall 132. FIG. 2 is a cross-sectional view along the line II-II of FIG. 1 showing the mounting state of the ventilation unit 10 (the ventilation unit 10 of the upper ventilation apparatus 1A), and FIG. 3 is a front view of the fuel cell stack 100 with the ventilation unit 10 removed. Although not shown, the ventilation unit 10 of the lower ventilation apparatus 1B is attached in the same manner as the ventilation unit 10 of the upper ventilation apparatus 1A.

As shown in FIGS. 2 and 3, on the front surface of the front wall 132, substantially rectangular recesses 135 are provided in the upper portion above the middle portion in the up-down direction and in the lower portion below the middle portion in the up-down direction, respectively. The recesses 135 are formed in an elongated shape in the left-right direction. Furthermore, inside the recess 135, a recess 136 formed in an elongated shape in the left-right direction is provided. That is, a pair of upper and lower recesses 135 and 136 formed in a stepped shape are provided on the front surface of the front wall 132. The vertical lengths of the recesses 135 and 136 provided on the upper side and the vertical lengths of the recesses 135 and 136 provided on the lower side are equal to each other. On the other hand, the horizontal lengths of the recesses 135 and 136 provided on the upper side are longer than the horizontal lengths of the recesses 135 and 136 provided on the lower side, for example, about twice. In the front wall 132, a bottomed screw hole 138 is provided around the recess 135.

On the bottom surface of the recess 136, multiple communication holes 137 that penetrate the front wall 132 in the front-rear direction are opened. Specifically, as shown in FIG. 3, in the recess 136 on the upper side, a pair of upper and lower communication holes 137 each formed in a substantially rectangular shape are provided over four rows in the left-right direction. In the recess 136 on the lower side, a pair of upper and lower communication holes 137 each formed in a substantially rectangular shape are provided over two rows in the left-right direction. The shapes of the multiple communication holes 137 are all equal. The shape and number of the communication holes 137 are not limited to those described above.

Among the areas inside the recess 135, the area where a pair of upper and lower communication holes 137 are provided is defined as an opening area AR1, and the area where no communication holes 137 are provided is defined as a closed area AR2. The opening area ARI and the closed area AR2 exist alternately in the left-right direction through a partition line extending in the up and down direction. Therefore, the recess 135 on the upper side is provided with four opening areas ARI and three closed areas AR2 between them, and the recess 135 on the lower side is provided with two opening areas AR1 and one closed area AR2 between them. Furthermore, among the area inside the recess 135, in the area along the periphery of the recess 135, that is, in the right of the opening area ARI on the right end, in the left of the opening area ARI on the left end, and above and below the opening area AR1, the closed areas AR2 are also provided.

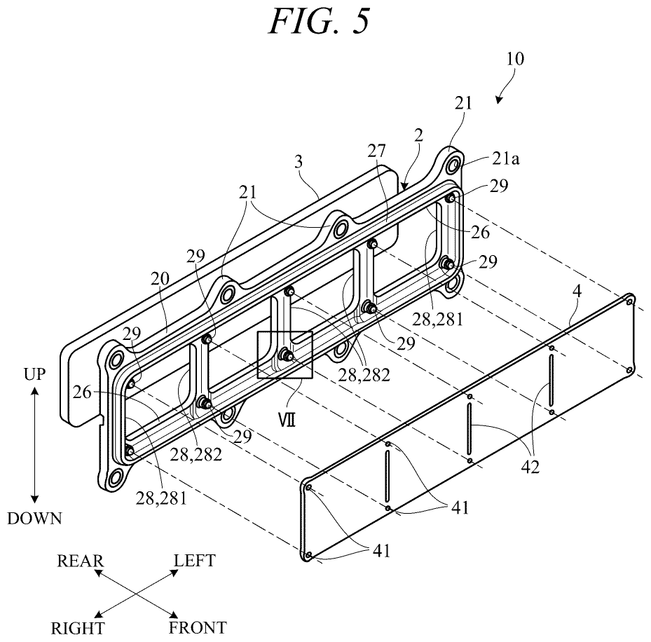

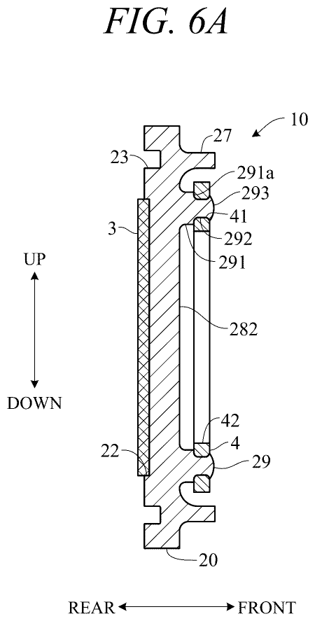

The ventilation unit 10 of the upper ventilation apparatus 1A and the ventilation unit 10 of the lower ventilation apparatus 1B have the same configuration, except for the difference in dimensions in the left-right direction. Therefore, the following mainly describes the configuration of the ventilation unit 10 of the upper ventilation apparatus 1A. FIG. 4 is a front view of the ventilation unit 10 of the upper ventilation apparatus 1A (viewed from the front), and FIG. 5 is an exploded perspective view. In FIG. 4, positions of the communication holes 137 when the ventilation unit 10 is attached to the front wall 132 of the case 130, are indicated by two-dot chain lines.

As shown in FIGS. 4 and 5, the ventilation unit 10 includes a substantially rectangular frame-shaped holding member 2, a substantially rectangular plate-shaped filter 3 mounted on the rear surface of the holding member 2, and a substantially rectangular plate-shaped cover 4 mounted on the front surface of the holding member 2. The holding member 2 and the cover 4 are made of resin and formed by resin molding. The filter 3 is made of a material that allows gases such as fuel gas and air to pass through, but prevents foreign matters such as dust from passing through.

The holding member 2 has a substantially flat plate-shaped base portion 20 and a plurality of fixing portions 21 protruding upward and downward from the peripheral edge of the base portion 20. In the fixing portion 21, a circular through-hole 21a that penetrates the fixing portion 21 is opened in the front-rear direction.

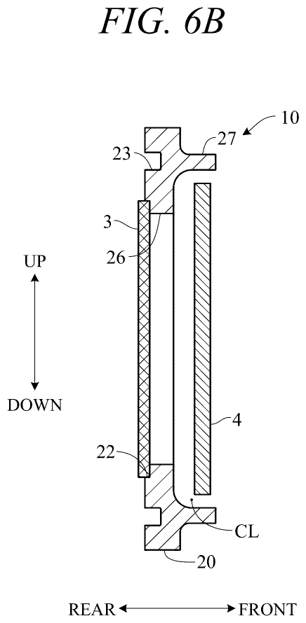

FIG. 6A is a cross-sectional view along line A-A of FIG. 4, and FIG. 6B is a cross-sectional view along line B-B of FIG. 4. As shown in FIGS. 6A and 6B, a substantially rectangular recess 22 corresponding to the outer shape of the filter 3 is provided on the rear surface of the base portion 20. The edge of the filter 3 fits into the recess 22. In this state, the filter 3 is joined to the base portion 20 by adhesion or welding. At this time, the rear surface of the filter 3 protrudes rearward from the rear surface of the base portion 20. Furthermore, on the rear surface of the base portion 20, a recess 23 is provided to surround the outer peripheral edge of the filter 3 all around the base portion 20. As shown in FIG. 2, a sealing member 24 fits into the recess 23.

As shown in FIG. 2, the outer peripheral edge of the filter 3 joined to the holding member 2 fits into the recess 136 of the front wall 132. The outer peripheral edge of the base portion 20 fits into the recess 135 on the front side of the recess 136. In this state, the bolt 5 inserted through the through-hole 21a (FIG. 5) of the fixing portion 21 is screwed into the screw hole 138, thereby fixing the holding member 2 to the case 130 through the filter 3. Between the peripheral surface of the recess 135 and the outer peripheral edge of the base portion 20, a sealing material 25 such as a gasket is provided.

As shown in FIG. 5, the base portion 20 is provided with four substantially rectangular window portions 26, which penetrate the base portion 20 in the front-rear direction and are arranged at equal intervals in the left-right direction. As indicated by the two-dot chain lines in FIG. 4, when the ventilation unit 10 is attached to the front wall 132, a pair of upper and lower communication holes 137 (the areas ARI in FIG. 3) are located inside the window portion 26. As shown in FIG. 5, a substantially rectangular wall portion 27 is projected forward on the front surface of the base portion 20 so as to surround the four window portions 26. The height (length in the front-rear direction) of wall portion 27 is constant throughout its entire area.

On the front surface of the base portion 20, multiple protrusions 29 of a predetermined height are provided. The protrusions 29 protrude forward inside and near the wall portion 27. Specifically, as shown in FIGS. 4 and 5, the base portion 20 has a substantially rectangular frame-shaped window frame portion 28 (a first window frame portion 281) that extends along the wall portion 27 to surround the entirety of multiple window portions 26, and a window frame portion 28 (second window frame portions 282) that cross inside the first window frame portion 281 to divide the inside of the first window frame portion 281 into multiple window portions 26. A pair of upper and lower protrusions 29 are provided on the second window frame portion 282. A pair of upper and lower protrusions 29 are also provided on the first window frame portion 281 at both the left and right ends. Among these protrusions 29, the upper protrusion 29 is located above the upper end of the window portion 26, and the lower protrusion 29 is located below the lower end of the window portion 26. As shown in FIG. 6A, the height (amount of protrusion forward) of the protrusion 29 is the same as or slightly lower than the height of the wall portion 27.

When the ventilation unit 10 is attached to the front wall 132, the protrusion 29 is located in the closed area AR2 of FIG. 3. At this time, multiple communication holes 137 in the front wall 132 face the multiple areas (window sections 26) divided by the second window frame portions 282 inside the first window frame portion 281, through the filter 3. In other words, multiple communication holes 137 are provided inside multiple window portions 26 so as not to intersect with the window frame portions 28 (first window frame portion 281, second window frame portion 282).

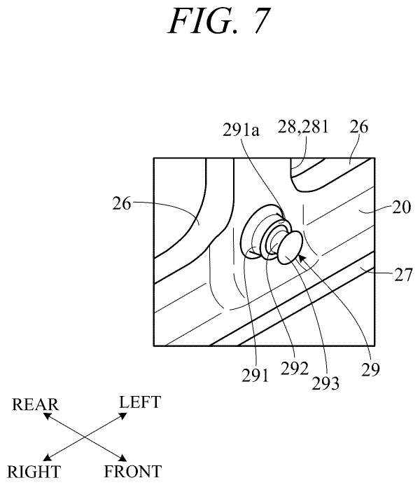

FIG. 7 is an enlarged view of part VII of FIG. 5. As shown in FIG. 7, the protrusion 29 has a substantially cylindrical large diameter portion 291 protruding forward from the front surface of the base portion 20, a substantially cylindrical small diameter portion 292 protruding forward from the central portion of the front end surface 291a of the large diameter portion 291, and an arc portion 293 protruding in a substantially arc shape forward from the front end of the small diameter portion 292. As shown in FIG. 6A, the diameter of the small diameter portion 292 is smaller than the diameters of the large diameter portion 291 and the arc portion 293. The length in the front-rear direction of the small diameter portion 292 is the same or almost the same as the thickness of cover 4.

As shown in FIG. 4, the length in the left-right direction of cover 4 is shorter than the length in the left-right direction of the inside of the rectangular frame-shaped wall portion 27, and the length in the up-down direction of the cover 4 is shorter than the length in the up-down direction of the inside of the wall portion 27. As shown in FIGS. 4 and 5, multiple substantially circular through-holes 41 are opened at the top and bottom end portions of the cover 4, corresponding to the positions of the protrusions 29. The diameter of the through-hole 41 is smaller than the diameters of the large diameter portion 291 and the arc portion 293 of protrusion 29 shown in FIG. 7, and is equal to or almost equal to the diameter of the small diameter portion 292.

As shown in FIG. 6A, the protrusion 29 fits into the through-hole 41 of the cover 4. More specifically, the arc portion 293 passes through the through-hole 41 while being elastically deformed, and the through-hole 41 fits onto the outer peripheral surface of the small diameter portion 292. This restricts the position of the cover 4 in the up-down direction and in the left-right direction with respect to the holding member 2. Furthermore, the rear surface of the cover 4 contacts the front end surface 291a of the large diameter portion 291, thereby restricting the position in the front-rear direction of the cover 4 with respect to the holding member 2. In other words, by fitting the protrusion 29 into the through-hole 41, the cover 4 is positioned in the front-rear direction and in the left-right direction, and up-and-down directions. After fitting into the through-hole 41, the protrusion 29 is joined to the cover 4, for example, by welding.

In the state where the cover 4 is attached to the protrusion 29, as shown in FIG. 6B, a gap (clearance CL) is provided around the entire periphery of the cover 4 between the base portion 20 of the holding member 2 and the cover 4, and between the wall portion 27 and the cover 4. Therefore, with the front surface of the filter 3 covered by the cover 4, air (running wind) can be flowed to the filter 3 from the front of the cover 4 through the clearance CL and the window portion 26.

As shown in FIGS. 5 and 6A, in the central portion of the cover 4 (excluding the right and left end portions), multiple elongated through-holes (slit holes 42) are opened so as to extend in the up-down direction between the upper through holes 41 and lower through-hole 41. When the ventilation unit 10 is attached to the front wall 132, the slit holes 42 face the closed areas AR2 of the front wall 132 shown in FIG. 3. As shown in

FIG. 4, the width in the left-right direction of the slit hole 42 is shorter than the width in the left-right direction of the second window frame portion 282 of the holding member 2. Thus, air can be flowed to the filter 3 from the front of the cover 4 through the slit holes 42 and the window portions 26.

Among a manufacturing method for a fuel cell, the manufacturing method for the ventilation apparatus 1 is as follows. First, as shown in FIG. 6A, the peripheral portion of the filter 3 is fitted into the recess 22 on the rear surface of the holding member 2, and then the filter 3 is joined to the holding member 2 by welding or the like (a filter attachment process). Next, the cover 4 is attached to the holding member 2 so as to cover the inside of the peripheral portion of the filter 3 (a cover attachment process). That is, the through-hole 41 of the cover 4 is fitted to the protrusion 29 on the front surface of the holding member 2, and then the cover 4 is joined to the holding member 2 by welding or the like. In the cover attachment process, the cover 4 is attached to the holding member 2 with a gap over the entire periphery of the periphery portion of the cover 4 between the periphery portion of the cover 4 and the holding member 2. This assembles the ventilation unit 10. Next, as shown in FIG. 2, the ventilation unit 10 is fitted into the recesses 135 and 136 on the front surface of the case 130, and the bolt 5 is fastened into the screw hole 138 to attach the holding member 2 to the case 130 (a holding member attachment process). Thus, the ventilation unit 10 is fixed to the case 130, and the ventilation apparatus 1 is manufactured.

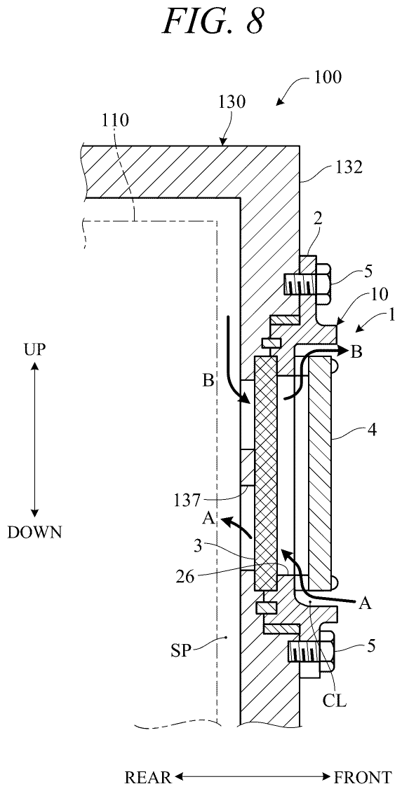

The main operation of the ventilation apparatus for the fuel cell configured as above is described. FIG. 8 is a diagram showing an example of the flow of air and fuel gas in the ventilation apparatus 1 according to this embodiment. When the ventilation unit 10 is attached to the case 130, as shown in FIG. 8, a clearance CL is provided around the entire periphery of the periphery portion of the cover 4 between the holding member 2 and the cover 4. During traveling of the vehicle, as shown by arrow “A” in FIG. 8, running wind is taken into the internal space SP of the case 130 through the clearance CL, the window portions 26 of the holding member 2, the filter 3, and the communication holes 137 of the front wall 132. The running wind is taken into the internal space SP not only through the clearance CL but also through the slit holes 42 of the cover 4 shown in FIG. 6A.

On the other hand, fuel gas leaked from the cell stacked body 110 into the internal space SP is discharged outside the case 130 through the communication holes 137 of the front wall 132, the filter 3, the window portions 26 of the holding member 2, and the clearance CL, as shown by arrow B in FIG. 8. This allows ventilating the internal space SPO of the case 130. In this embodiment, since the clearance CL through which air and fuel gas pass is provided around the entire periphery of the periphery portion of the cover 4, the flow area for air and fuel gas in the ventilation unit 10 increases. This allows for an increase in the flow rate of air taken into the internal space SP and the flow rate of fuel gas discharged from the internal space SP, enabling sufficient ventilation of the internal space SP.

The front surface of the filter 3 is covered with cover 4, except for the area where the slit holes 42 are provided. On the other hand, in the area where the slit holes 42 are provided, as shown in FIG. 6A, the front surface of the filter 3 is covered with the second window frame portion 282. Therefore, it is possible to prevent raindrops and foreign matters from colliding with the filter 3 through the slit holes 42 during traveling of the vehicle. It is also possible to prevent washing water from colliding with the filter 3 during high-pressure washing of the vehicle. Therefore, it is possible to protect filter 3, improving the durability of the ventilation unit 10. When cleaning or replacing the filter 3, the bolt 5 (FIG. 8) is loosened and the ventilation unit 10 is removed from the case 130. This makes it easy to clean or replace the filter 3.

According to the present embodiment, the following operations and effects are achievable.

(1) A ventilation apparatus 1 includes a case 130 that accommodates a cell stacked body 110 formed by stacking a plurality of power generation cells 111, and a ventilation unit 10 attached to the case 130 so as to cover a communication hole 137 provided on the case 130 through which the internal space SP and the external space of the case 130 communicate (FIGS. 1 and 2). The ventilation unit 10 includes a filter 3 disposed facing a communication hole 137, a frame-shaped holding member 2 attached to the case 130 while holding the peripheral portion of the filter 3, and a cover 4 attached to the holding member 2 so as to cover the inside of the peripheral portion of the filter 3 (FIG. 2). The cover 4 is attached to the holding member 2 with a gap (clearance CL) provided over the entire circumference of the periphery portion of the cover 4 between the periphery portion of the cover 4 and the holding member 2 (FIGS. 5 and 6B).

As a result, the flow path area of the ventilation unit 10 increases when outside air is taken into the internal space SP of the case 130, allowing a large volume of outside air to be taken into the internal space SP. Consequently, the internal space SP can be sufficiently ventilated. Furthermore, since the front surface of the filter 3 is covered by the cover 4, it is possible to prevent raindrops and foreign matters from colliding with the filter 3 during traveling of the vehicle, and washing water from colliding with the filter 3 during high-pressure washing of the vehicle, thereby suppressing damage to the filter 3.

(2) The holding member 2 has a first window frame portion 281 with a frame shape, and a second window frame portion 282 that crosses the inside of the first window frame portion 281 and divides the first window frame portion 281 (FIGS. 4 and 5). In the cover 4, a slit hole 42 is provided at a position facing the second window frame portion 282 (FIG. 5). Thus, outside air can be taken into the internal space SP from the central portion of the cover 4 through the slit hole 42, allowing the ventilation of the internal space SP to be performed more efficiently. Moreover, since the slit hole 42 faces the second window frame portion 282, it can also prevent high-pressure washing water and the like that flows in through the slit hole 42 from colliding with the filter 3.

(3) The holding member 2 has a protrusion 29 that protrudes towards the cover 4 (FIG. 5). A through-hole 41 is provided in the cover 4, and the protrusion 29 is fitted into the through-hole 41 and is coupled with the cover 4 (FIG. 5). This allows the cover 4 to be supported by the holding member 2 with a clearance CL provided between the holding member 2 and the periphery portion of the cover 4. Furthermore, by adjusting the length of the protrusion 29, the size of the clearance CL can be easily set.

(4) The protrusion 29 has a large diameter portion 291 and a small diameter portion 292, which are step-shaped to regulate the position of the cover 4 relative to the holding member 2. This makes it easy to attach the cover 4 to the holding member 2. Moreover, it is possible to precisely regulate the position of the cover 4 relative to the holding member 2.

(5) A manufacturing method for a fuel cell is a method for manufacturing the fuel cell including a case 130 accommodating a cell stacked body 110 formed by stacking a plurality of power generation cells 111 and a ventilation unit 10 attached to the case 130 so as to cover a communication hole 137 provided at the case 130 through which an internal space SP and an external space of the case 130 communicate. The manufacturing method includes a filter attachment process of attaching the peripheral portion of a filter 3 arranged to face the communication hole 137 to a frame-shaped holding member 2, a cover attachment process of attaching a cover 4 to the holding member 2 so as to cover the inside of the peripheral portion of the filter 3, and a holding member attachment process of attaching the holding member 2 to the case 130. The cover attachment process includes attaching the cover 4 to the holding member 2 with a gap (clearance CL) over the entire circumference of the periphery portion of the cover 4 between the peripheral portion of the cover 4 and the holding member 2. Thus, it is possible to easily manufacture a ventilation apparatus 1 capable of taking in a sufficient amount of outside air into the internal space SP of the case 130.

(6) The cover attachment process includes fitting a protrusion 29 projecting from the holding member 2 into a through-hole 41 provided in the cover 4 and welding the protrusion 29 and the cover 4. This allows the cover 4 to be easily and accurately attached to the holding member 2.

In the above embodiment, the ventilation units 10 are attached to both the upper and lower portions of the front wall 132 of the case 130, but an attachment position of a ventilation unit is not limited to those described above. In the above embodiment, the ventilation unit 10 is attached to the case 130 so as to cover the communication hole 137 for communicating with the internal space SP of the case 130, but as long as it is attached to cover an opening communicating an internal space and an external space of a case, the shape of an opening can be any shape.

In the above embodiment, the holding member 2 has a first window frame portion 281 (a frame portion) formed in a frame shape and a second window frame portion 282 (a crossing portion) that crosses the inside of the first window frame portion 281 and divides the first window frame portion 281, but the configurations of the frame portion and the crossing portion are not limited to those described above. In the above embodiment, a slit hole 42 is provided at a position facing the second window frame portion 282 of the cover 4, but the shape of an opening is not limited to those described above.

In the above embodiment, a protrusion 29 is projected from the holding member 2 towards the cover 4, but the configuration of a protrusion is not limited to those described above. In the above embodiment, the protrusion 29 is fitted into the through-hole 41 of the cover 4. That is, the through-hole 41 as a joined portion is provided so that the protrusion fits and joins, but the joined portion may be provided so that the protrusion engages and joins. In the above embodiment, a large diameter portion 291 and a small diameter portion 292 are provided on the protrusion 29 to position the cover 4, but the configuration of a positioning portion formed in a stepped shape that regulates the position of the cover relative to the holding member is not limited to those described above.

In the above embodiment, an example of applying the ventilation apparatus 1 to a fuel cell mounted on a vehicle is described, but a ventilation apparatus of the present invention can also be applied to fuel cells mounted on various industrial machines in addition to a moving body other than a vehicle such as an aircraft or a boat, a robot, and the like.

The above embodiment can be combined as desired with one or more of the above modifications. The modifications can also be combined with one another.

According to the present invention, it is possible to sufficiently take in outside air into a fuel cell case.

Above, while the present invention has been described with reference to the preferred embodiments thereof, it will be understood, by those skilled in the art, that various changes and modifications may be made thereto without departing from the scope of the appended claims.

What is claimed is:

1. A ventilation apparatus for a fuel cell comprising:
a fuel cell case accommodating a stacked body formed by stacking a plurality of power generation cells; and
a ventilation unit attached to the fuel cell case so as to cover an opening provided at the fuel cell case, an internal space and an external space of the fuel cell case communicating through the opening, wherein
the ventilation unit includes:
a filter disposed facing the opening;
a holding member formed in a frame shape and attached to the fuel cell case to hold a peripheral portion of the filter; and
a cover attached to the holding member so as to cover an inside of the peripheral portion of the filter, and
the cover is attached to the holding member with a gap over an entire circumference of a peripheral portion of the cover between the peripheral portion of the cover and the holding member.

2. The ventilation apparatus according to claim 1, wherein
the holding member includes a frame portion and a crossing portion crossing inside the frame portion so as to divide the frame portion, and
an opening is provided at a position facing the crossing portion in the cover.

3. The ventilation apparatus according to claim 1, wherein
the holding member includes a protrusion protruding toward the cover, and
the cover includes a joined portion joined by fitting or engaging with the protrusion.

4. The ventilation apparatus according to claim 3, wherein
the protrusion includes a positioning portion formed in a stepped shape to regulate a position of the cover with respect to the holding member.

5. The ventilation apparatus according to claim 2, wherein
the holding member is divided into a plurality of regions by the crossing portion, and
the opening of the fuel cell case includes a plurality of openings, and
the plurality of openings of the fuel cell case and the plurality of regions faces each other with the filter interposed therebetween.

6. The ventilation apparatus according to claim 1, wherein
the fuel cell case includes a side wall extended in a stacking direction of the plurality of power generation cells, and
the ventilation unit is attached to the side wall of the fuel cell case.

7. The ventilation apparatus according to claim 1, wherein
the holding member includes a wall portion with a frame shape protruded in an attachment direction of the cover so as to surround the peripheral portion of the cover.

8. A manufacturing method for a fuel cell, the fuel cell including a fuel cell case accommodating a stacked body formed by stacking a plurality of power generation cells and a ventilation unit attached to the fuel cell case so as to cover an opening provided at the fuel cell case, an internal space and an external space of the fuel cell case communicating through the opening,
the manufacturing method comprising:
attaching a peripheral portion of a filter arranged to face the opening to a holding member with a frame shape;
attaching the holding member to the fuel cell case; and attaching a cover to the holding member so as to cover an inside of the peripheral portion of the filter, wherein
the attaching the cover includes attaching the cover to the holding member with a gap over an entire circumference of a peripheral portion of the cover between the peripheral portion of the cover and the holding member.

9. The manufacturing method according to claim 8, wherein
the attaching the cover includes fitting or engaging a protrusion protruding from the holding member with a joined portion provided on the cover and welding the protrusion and the joined portion together.
